(19) United States
(12) Patent Application Publication
(10) Pub. No.: US 2005/0141556 A1
(43) Pub. Date: Jun. 30, 2005

(54) System and method for controlling bit stream in digital data

(76) Inventors: Chung-Yen Lu, Taipei City (TW); Hong-Hui Chen, Hsin-Chuang City (TW); Chi-Hui Huang, Taipei City (TW)

Correspondence Address: Hoffman, Warnick & D'Alessandro LLC, Three E-Comm Square, Albany, NY, 12207, US

(21) Appl. No.: 11/017,282

(22) Filed: Dec. 20, 2004

(30) Foreign Application Priority Data
Dec. 26, 2003 (TW) 092137183

(51) Int. Cl. H04J 3/16

(52) U.S. Cl. 370/468

(57) ABSTRACT

The present invention is a bits stream control system for digital data. The bits stream control system comprises an encoder, a bits stream truncator, and a buffer. The encoder is used for encoding the digital data into a plurality of bits streams. The bits stream truncator is used for truncating or not truncating each of the bits streams to generate a plurality of corresponding modified bits streams according to a predetermined bit budget policy. The buffer is used for storing the modified bits streams.

### BACKGROUND OF THE INVENTION

1. Field of the Invention

The present invention relates to a bits stream control system for digital data, especially to a bits stream control system in compliance with digital video specification for digital data.

2. Description of the Prior Art

The image encoder of the prior art encodes digital data to a plurality of bits streams via the steps of transformation, quantization, and variable length coding (VLC) according to a predetermined encoding format; these formats include the moving pictures experts groups (MPEG), the joint photographic experts groups (JPEG), or the DV specification popularized by Sony, Matsushita, Philips, Thomson, and so on in 1993. After encoding, the image encoder of the prior art further processes the bits streams according to function and purpose.

When the encoder is applied in a DV apparatus, each of the bits streams generated by the DV specification is assigned to a corresponding sub-block by a bits assignment apparatus to constitute a segment. The DV specification also defines that the segment comprises five macroblocks; each of the macroblocks comprises four luma sub-blocks and two chroma sub-blocks, and each of the luma sub-blocks comprises 112 bits while each of the chroma sub-blocks comprises 80 bits.

The assignment steps of the bits assignment apparatus is described in the following:

(1) Judge whether the number of bits of an assigned bits stream of the bits streams exceeds the desired number of the corresponding sub-blocks.

(2) If yes, truncate the extra bits from the assigned bits stream, assign the truncated and assigned bits stream to the corresponding sub-block, and buffer the extra bits into an extra bits buffer; otherwise, assign the assigned bits stream to the corresponding sub-block directly.

(3) Repeat steps (1) and (2) until the bits streams are all assigned to the corresponding sub-blocks.

(4) Read the extra bits from the extra bits buffer, and assign the extra bits to the remaining capacity of the other sub-blocks.

For economical and practical use, the extra bits buffer of the prior art usually has the memory capacity of about 2K to 8 K bytes. Therefore, if the extra bits of one bits stream are too large, the extra bits will occupy most of the capacity, even all capacity, of the extra bits buffer, and the other extra bits will be lost. Accordingly, if the other extra bits contain important data, the important data will be lost, resulting in worse distortion when the digital data is restored subsequently.

### SUMMARY OF THE INVENTION

The objective of the present invention is to provide a bits stream control system for digital data, so as to solve the problem of the prior art.

The bits stream control system of the present invention modifies the bits streams according to a predetermined bit budget policy after the encoder of the prior art encodes the digital data to a plurality of bits streams via the steps of transformation, quantization, and variable length coding (VLC) according to a predetermined encoding format, so as to reduce the number of bits of the extra bits for generating a plurality of corresponding modified bits streams. The present invention can avoid the situation where the extra bits are too large, the extra bits will occupy most of the capacity, even all capacity, of the extra bits buffer, and the other extra bits will be lost.

The present invention is a bits stream control system for digital data. The bits stream control system comprises an encoder, a bits stream truncator, and a buffer. The encoder is used for encoding the digital data to a plurality of bits streams. The bits stream truncator is used for truncating or not truncating each of the bits streams to generate a plurality of corresponding modified bits streams according to a predetermined bit budget policy. The buffer is used for storing the modified bits streams.

The advantage and spirit of the invention may be understood by the following recitations together with the appended drawings.

### BRIEF DESCRIPTION OF THE APPENDED DRAWINGS

FIG. 1 is a schematic diagram of the bits stream control system of the first embodiment according to the present invention.

FIG. 2 is a calculation flowchart of the predetermined bit budget policy of the first embodiment.

FIG. 3 is a schematic diagram of the bits stream control system of the second embodiment according to the present invention.

FIG. 4 is a flowchart of the bits stream control system of the second embodiment.

### DETAILED DESCRIPTION OF THE INVENTION

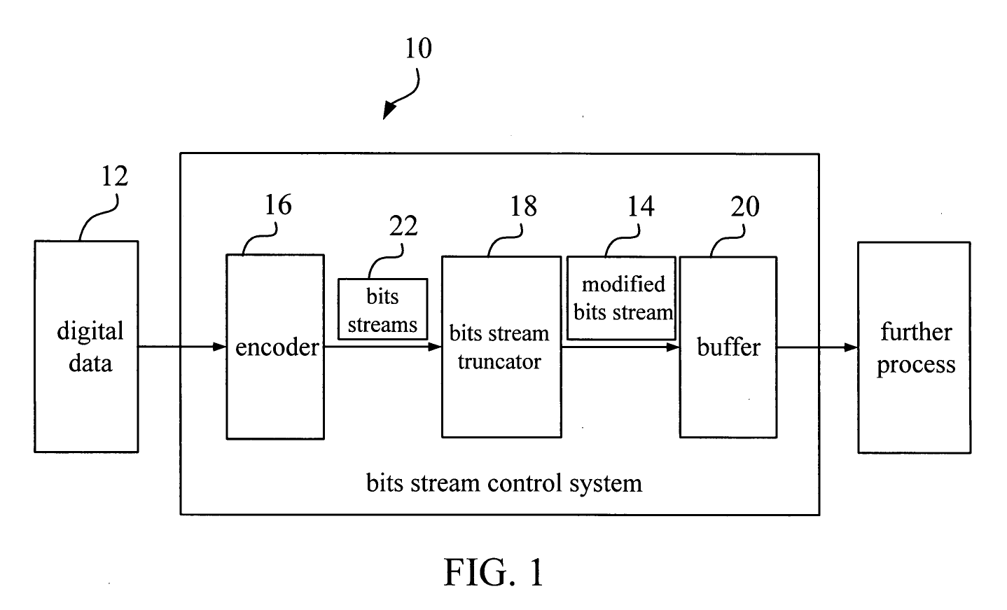

Please refer to FIG. 1. FIG. 1 is a schematic diagram of the bits stream control system 10 of the first embodiment according to the present invention. The bits stream control system 10 of the first embodiment comprises an encoder 16, a bits stream truncator 18, and a buffer 20.

The encoder 16 first transforms a digital data 12 to a digital data of frequency domain (not shown), quantifies the digital data of frequency domain to a modified digital data (not shown), and then encodes the modified digital data to a plurality of bits streams 22 according to a predetermined encoding format; these formats include the moving pictures experts groups (MPEG), the joint photographic experts groups (JPEG), or the digital video (DV).

The bits stream truncator 18 is used for truncating or not truncating each of the bits streams 22 to generate a plurality of corresponding modified bits streams 14 according to a predetermined bit budget policy and for buffering the modified bits streams 14 into the buffer 20. The bit budget policy calculates a bit length (not shown) of each modified bits stream 14 according to a budget capacity (not shown) provided by the buffer 20.

The bits stream truncator 18 examines each of the bits streams 22 sequentially according to the bit budget policy. If a currently examined bits stream 22 doesn't conform to the bit budget policy, the bit budget policy truncates the currently examined bits stream 22 according to the budget capacity and adds an end mark to form a corresponding modified bits stream 14; otherwise, the bit budget policy doesn't truncate the currently examined bits stream 22 and output the currently examined bits stream 22 as the corresponding modified bits stream 14.

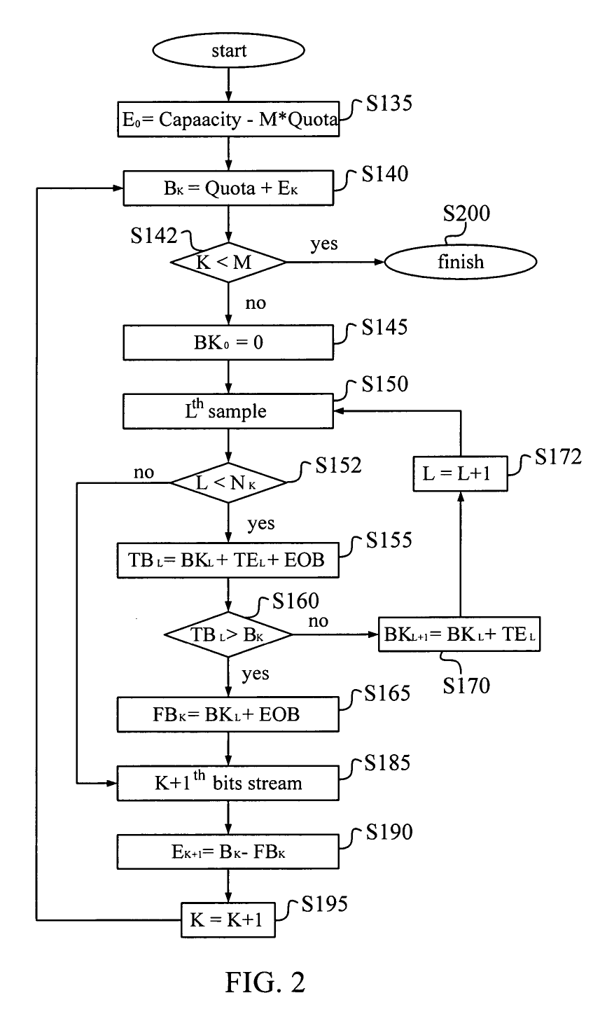

Please refer to FIG. 2. FIG. 2 is a calculation flowchart of the predetermined bit budget policy of the first embodiment. The number of bits streams is M, and the K^{th} bits stream 22 represents a corresponding bits stream 22, wherein K=0˜M−1. The K^{th} bits stream 22 comprises N_{K} samples, and the L^{th} sample represents a corresponding sample, wherein L=0˜N_{K}−1. The bits stream truncator 18 processes each of the bits streams 22 and the sample of each bits stream 22 sequentially. The steps are described in the following:

Step S135: Calculate a 0^{th} remaining capacity of the buffer 20 corresponding to a oth bits stream 22, and the equation is described in the following:
E₀=Capacity−M*Quota,
wherein E₀ represents the 0^{th} remaining capacity, and Capacity represents the total capacity of the buffer 20; Quota represents a guaranteed bit length, and the guaranteed bit length is a fixed capacity in the buffer 20 pre-reserved for each bits stream 22.

Step S140: Calculate a K^{th} budget capacity, K=0˜M−1, and the equation is described in the following:
B_{K}=Quota+E_{K}
wherein B_{K} represents the K^{th} budget capacity, and E_{K} represents a K^{th} remaining capacity.

Step S142: Judge whether K is smaller than M. If yes, go to step S145; otherwise, go to step S200.

Step S145: Set the length (BK₀) of a oth temporarily modified bits stream to be 0.

Step S150: Input an L^{th} sample of the K^{th} bits stream 22, wherein L=0˜N_{K}−1.

Step S152: Judge whether L is smaller than N_{K}. If yes go to step S155; otherwise, go to step S185.

Step S155: Calculate an L^{th} temporary bit length, and the equation is described in the following:
TB_{L}=BK_{L}+TE_{L}+EOB
wherein TB_{L} represents the L^{th} temporary bit length, and BKL represents the length of the L^{th} temporarily modified bits stream; TE_{L} represents the L^{th} sample, and EOB represents the end mark.

Step S160: Judge whether TB_{L} is larger than the corresponding B_{K}. If yes, go to step S165; otherwise, go to step S170.

Step S165: Calculate the bit length of a K^{th} modified bits stream, and the equation is described in the following:
FB_{K}=BK_{L}+EOB
wherein FB_{K} represents the bit length of the K^{th} modified bits stream; go to step S185.

Step S170: Calculate the length of an L+1^{th} temporarily modified bits stream, and the equation is described in the following:
BK_{L+1}=BK_{L}+TE_{L}
wherein BK_{L+1} represents the length of the L+1^{th} temporarily modified bits stream.

Step S172: Repeat step S150 to calculate the L+1^{th} sample.

Step S185: Input the K+1^{th} bits stream.

Step S190: Calculate the K+1^{th} remaining capacity, and the equation is described in the following:
E_{K+1}=B_{K}−FB_{K}

Step S195: Repeat step S140 to calculate the K+1^{th} budget capacity.

Step S200: Finish.

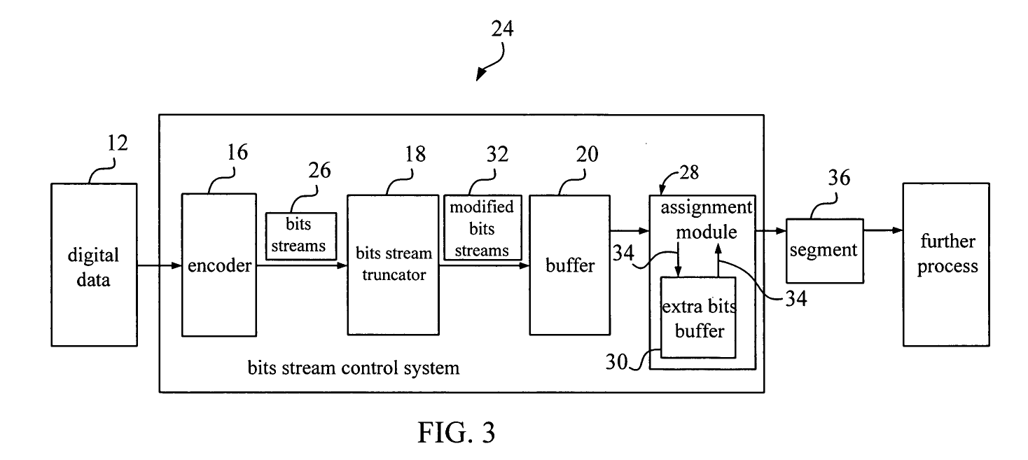

Please refer to FIG. 3. FIG. 3 is a schematic diagram of the bits stream control system 24 of the second embodiment according to the present invention. In the second embodiment, the bits stream control system 24 is applied in the digital video (DV), and a plurality of bits streams 26 conform to a digital video specification. Beside the encoder 16, the bits stream truncator 18, and the buffer 20 shown in FIG. 1, the bits stream control system 24 further comprises an assignment module 28. The assignment module 28 comprises an extra bits buffer 30.

The assignment module 28 is used for assigning each modified bits stream 32 buffered in the buffer 20 to a corresponding sub-block (not shown) respectively. The corresponding sub-block comprises a block length. If the bit length of a currently assigned-modified bits stream 32 exceeds the block length of the corresponding sub-block, the assignment module 28 truncates an extra bit 34 from the bits stream 32, buffers the extra bit 34 into the extra bits buffer 30, adds a corresponding end mark to the truncated-modified bits stream 32, and assigns the truncated-modified bits stream 32 to the corresponding sub-block; otherwise, the assignment module 28 assigns the currently assigned-modified bits stream 32 to the corresponding sub-block directly.

After each of the modified bits streams 32 is assigned to the corresponding sub-block, the assignment module 28 reads each extra bit 34 from the extra bits buffer 30, assigns each extra bit 34 to a sub-block that has remaining capacity, and finally enables the corresponding sub-blocks of the modified bits streams 32 to form a segment 36. The segment 36 comprises five macroblocks, and each of the macroblocks comprises four luma sub-blocks and two chroma sub-blocks; each of the luma sub-blocks comprises 112 bits, and each of the chroma sub-blocks comprises 80 bits.

As shown in FIG. 2 with M number of bits streams 22, M can be 6, which means a cycle can process 6 sub-blocks of a macroblock when performing the truncation procedure each time; M can also be 30, which means a cycle can process 30 sub-blocks of a macroblock when performing the truncation procedure each time.

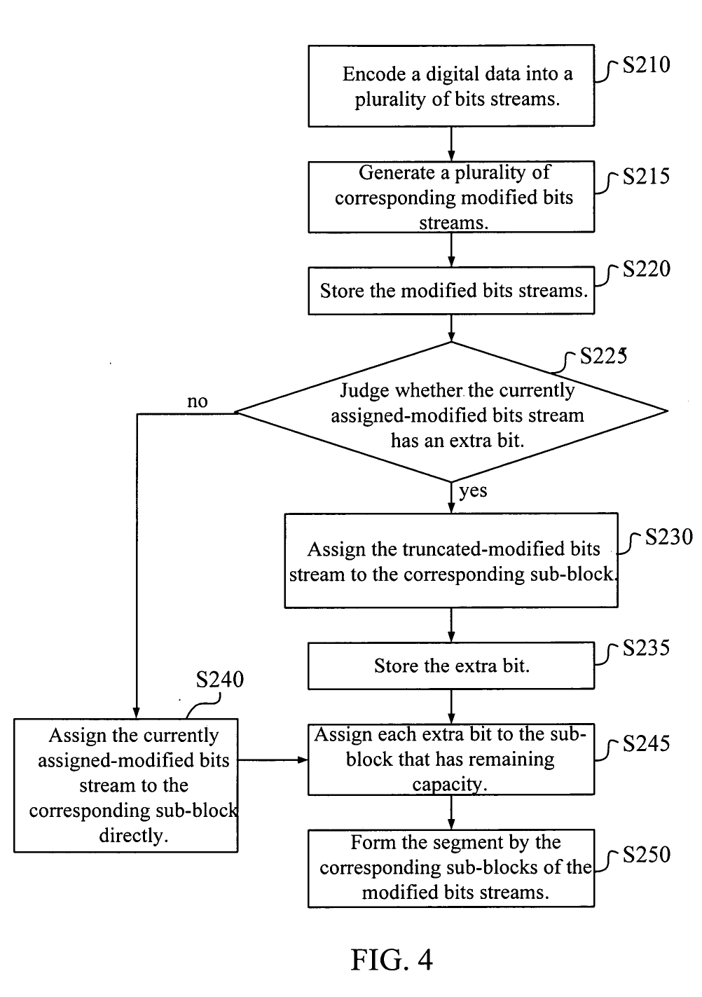

Please refer to FIG. 4. FIG. 4 is a flowchart of the bits stream control system 24 of the second embodiment. According to the above, the second embodiment comprises the following steps:

Step S210: Encode a digital data 12 into a plurality of bits streams 26.

Step S215: Truncate or not truncate each of the bits streams 26 to generate a plurality of corresponding modified bits streams 32 according to the predetermined bit budget policy.

Step S220: Store the modified bits streams 32.

Step S225: Judge whether the currently assigned-modified bits stream 32 has an extra bit 34. If yes, go to step S230; otherwise, go to step S240.

Step S230: Truncate the extra bit 34 from the currently assigned-modified bits stream 32, add a corresponding end mark to the truncated-modified bits stream 32, and assign the truncated-modified bits stream 32 to the corresponding sub-block.

Step S235: Store the extra bit 34 and go to step S245.

Step 240: Assign the currently assigned-modified bits stream 32 to the corresponding sub-block directly.

Step S245: Assign each extra bit 34 to the sub-block that has remaining capacity.

Step S250: Form the segment 36 by the corresponding sub-blocks of the modified bits streams 32.

In the prior art, after the encoder encodes the digital data into bits streams, the bits assignment apparatus assigns each of the bits streams to the corresponding sub-blocks directly to form the segment. Therefore, if the extra bits of one of the bits streams are too large, the extra bits will occupy most of the capacity, even all capacity, of the extra bits buffer, and the other extra bits will be lost, resulting in worse distortion when the digital data is restored subsequently. The bits stream control systems 10 and 24 of the present invention modify the bits streams 22, 26 by the predetermined bits budget policy to generate the corresponding modified bits streams 14, 32 before the assignment module 28 performs assignment procedure. Accordingly, each bits stream 22, 26 can be examined in advance, and the extra bits of the prior art can be modified for further process.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A bits stream control system for digital data comprising:
an encoder for encoding the digital data to a plurality of bits streams;
a bits stream truncator for truncating or not truncating each of the bits streams to generate a plurality of corresponding modified bits streams according to a predetermined bit budget policy; and
a buffer for storing the modified bits streams.

2. The bits stream control system of claim 1, wherein the bit budget policy is used for calculating a bit length of each modified bits stream.

3. The bits stream control system of claim 2, wherein the bit budget policy calculates the bit length of each modified bits stream according to a budget capacity provided by the buffer.

4. The bits stream control system of claim 3, wherein the budget capacity is generated based on a guaranteed bit length and a remaining capacity, the guaranteed bit length is a fixed capacity in the buffer pre-reserved for each bits stream, and the remaining capacity is obtained by subtracting the used capacity and the pre-reserved capacity from the total capacity of the buffer.

5. The bits stream control system of claim 4, wherein the bit budget policy examines each of the bits streams sequentially, if a currently examined bits stream doesn't conform to the bit budget policy, the bit budget policy truncates the currently examined bits stream according to the budget capacity and adds an end mark to form a corresponding modified bits stream; otherwise, the bit budget policy doesn't truncate the currently examined bits stream and output the currently examined bits stream as the corresponding modified bits stream.

6. The bits stream control system of claim 5, wherein the bits stream control system further comprises:
an assignment module for assigning each modified bits stream to a corresponding sub-block respectively, the corresponding sub-block comprising a block length.

7. The bits stream control system of claim 6, wherein the assignment module further comprises:
an extra bits buffer for storing an extra bit of each modified bits stream exceeding the block length of the corresponding sub-block.

8. The bits stream control system of claim 7, wherein the bits streams conform to a digital video specification.

9. The bits stream control system of claim 8, wherein the corresponding sub-blocks of the modified bits streams constitute a segment.

10. The bits stream control system of claim 9, wherein the segment comprises five macroblocks, each of the macroblocks comprises four luma sub-blocks and two chroma sub-blocks, each of the luma sub-blocks comprises 112 bits, and each of the chroma sub-blocks comprises 80 bits.

11. A bits stream control method for digital data comprising:
encoding a digital data into a plurality of bits streams;
truncating or not truncating each of the bits streams to generate a plurality of corresponding modified bits streams according to a predetermined bit budget policy; and
storing the modified bits streams by a buffer.

12. The bits stream control method of claim 11, wherein the bit budget policy is used for calculating a bit length of each modified bits stream.

13. The bits stream control method of claim 12, wherein the bit budget policy calculates the bit length of each modified bits stream according to a budget capacity.

14. The bits stream control method of claim 13, wherein the budget capacity is generated based on a guaranteed bit length and a remaining capacity, the guaranteed bit length is a fixed capacity in the buffer pre-reserved for each bits stream, and the remaining capacity is obtained by subtracting the used capacity and the pre-reserved capacity from the total capacity of the buffer.

15. The bits stream control method of claim 14, wherein the bit budget policy examines each of the bits streams sequentially, if a currently examined bits stream doesn't conform to the bit budget policy, the bit budget policy truncates the currently examined bits stream according to the budget capacity and adds an end mark to form a corresponding modified bits stream, otherwise the bit budget policy doesn't truncate the currently examined bits stream and output the currently examined bits stream as the corresponding modified bits stream.

16. The bits stream control method of claim 15, wherein the modification method further comprises:
assigning each modified bits stream to a corresponding sub-block respectively.

17. The bits stream control method of claim 16, wherein the modification method further comprises:
storing an extra bit of each modified bits stream exceeding the block length of the corresponding sub-block.

18. The bits stream control method of claim 17, wherein the bits streams conform to a digital video specification.

19. The bits stream control method of claim 18, wherein the corresponding sub-blocks of the modified bits streams constitute a segment.

20. The bits stream control method of claim 19, wherein the segment comprises five macroblocks, each of the macroblocks comprises four luma sub-blocks and two chroma sub-blocks, each of the luma sub-blocks comprises 112 bits, and each of the chroma sub-blocks comprises 80 bits.

21. A method for bit stream truncation comprising:
receiving variable length coding symbols for receiving variable length coding bits representing a coding symbol;
accumulating the bits of coding symbols;
determining whether the accumulated bits larger than a predetermined value;
replacing a coding symbol with a special symbol when the accumulated bits larger than the predetermined value; and
abandoning remaining variable length coding symbols when the accumulated bits larger than the predetermined value.
